(19) United States
(12) Patent Application Publication
(10) Pub. No.: US 2011/0035152 A1
(43) Pub. Date: Feb. 10, 2011

(54) AUTONOMOUS WELLBORE NAVIGATION DEVICE

(76) Inventors: Claude Durocher, Neuilly-sur-Seine (FR); Gordon Smith, Aberdeenshire (GB)

Correspondence Address: SCHLUMBERGER OILFIELD SERVICES, 200 GILLINGHAM LANE, MD 200-9, SUGAR LAND, TX, 77478, US

(21) Appl. No.: 12/743,624

(22) PCT Filed: Nov. 21, 2008
(86) PCT No.: PCT/EP2008/009907

§ 371 Date: Oct. 24, 2010

(30) Foreign Application Priority Data
Nov. 22, 2007 (EP) 07121304.5

(51) Int. Cl. G06F 19/00; E21B 47/09

(52) U.S. Cl. 702/6

(57) ABSTRACT

A borehole apparatus capable of autonomously estimating its position in a borehole and controlling the actions of a downhole tool located in the borehole. The apparatus comprising a body, at least one measurement device capable of measuring a parameter of the borehole or the distance traveled by the device, a computer system located in the body, and a power system. The computer system comprises a processor arranged to receive data from the at least one measurement device and to calculate the position of the apparatus in the borehole, and a data storage device capable of storing data that have been processed by the processor and for storing instructions to control the actions of the downhole tool. The computer system is configured to process the data gathered from the at least one measurement device to estimate the position of the downhole device using a Bayesian approach and configured to provide output signals to control an action of the downhole tool dependant on the position of the apparatus in the borehole.

### CROSS-REFERENCE TO RELATED APPLICATIONS

The present application is based on and claims priority to EP Application No. 07121304.5, filed 22 Nov. 2007; and International Patent Application No. PCT/EP2008/009907, filed 21 Nov. 2008. The entire contents of each are herein incorporated by reference.

### TECHNICAL FIELD

This invention relates to the method and tool for estimating the position of an autonomous downhole device in a wellbore.

### BACKGROUND ART

There are a number of situations where it is desirable to estimate accurately the position of an apparatus in a wellbore. For example when making a wireline log or analyzing a slickline log, the position of the logging tool is needed when each measurement is made. When intervening in a well with coiled tubing the position of the tool at the end of the tubing is required; when drilling, the location of the bottom hole assembly and bit is needed, and when inserting an autonomous device into a wellbore, the device should be able to determine its own position.

Generally application specific dead-reckoning approaches are used to estimate the position of the apparatus in the wellbore. Such dead-reckoning techniques include measuring the length of wireline, drill pipe or coiled tubing reeled out, using an odometer on a wheeled device to measure the distance traveled or using inertial navigation. However relying on such approaches to measure the distance traveled can result in errors in the measurements due to conveyance stretch, conveyance compression, coiling of the tubing in the borehole or the odometer may slip. Because of this the size of the errors in the measurement typically increases as the distance traveled increases.

Other approaches used to determine the position of a device in a borehole include landmark recognition, such as where the downhole device is fitted with a casing collar locator (CCL) which can sense when the tool is adjacent a casing joint. However the CCL may fail to detect the joint or may detect a non-existent collar due to noise, and for an absolute position to be determined the positions of the casing joints must be known beforehand. A further approach, map-matching, provides the downhole device with sensors which are able to measure some characteristic of the wellbore environment, i.e. a gamma-ray sensor to measure the amount of gamma-rays being emitting from the surrounding formation. If the gamma-ray profile is well known the sensors reading can be correlated with the profile and the position can be determined. However this approach can be affected from sensor noise and have problems similar to that encountered with landmark recognition approaches. Examples of downhole devices that use such approaches are described in U.S. Pat. No. 6,378,627 and U.S. Pat. No. 6,845,819. Furthermore to make use of the positioning data obtained, it is often required that communication with the surface is needed for the operator or surface-based systems to make decisions and/or control the device based on its position.

U.S. Pat. No. 6,378,627 discloses a downhole tool for performing a desired operation in a wellbore. Data obtained downhole is used to control the operation of the tool or cause the tool to take various actions, such as initiating changes in the operation of various other downhole tools. The depth of the device is monitored by sensors, such as a casing collar locator (CCL).

U.S. Pat. No. 6,845,819 also discloses an autonomous unit for performing logging and remedial operations in a wellbore. It also uses sensors to identify locations in the well where it is to perform logging or remedial operations.

US2004/0168797 describes using a Bayesian technique to estimate the position of a downhole device as it tracks along the borehole. Data from sensors is transmitted uphole and the calculations using the Bayesian approach are performed by a surface computer to track the device in real-time.

It is the object of the invention to provide a borehole apparatus that is capable of autonomously determining its location accurately in a wellbore to initiate performance of a predetermined task by a downhole tool at a particular location.

### DISCLOSURE OF THE INVENTION

Accordingly a first aspect of the invention comprises a borehole apparatus capable of autonomously estimating its position in a borehole and controlling the actions of a downhole tool located in the borehole, the apparatus comprising: a body; at least one measurement device capable of measuring a parameter of the borehole and/or the distance traveled by the device; a computer system located in the body, the computer system comprising; a processor arranged to receive data from the measurement device and to calculate the position of the apparatus in the borehole; and a data storage device capable of storing data that have been processed by the processor and for storing instructions to control the actions of the downhole tool; and a power system; wherein the computer system is configured to process the data gathered from the measurement device to estimate the position of the downhole device using a Bayesian approach and configured to provide output signals to control an action of the downhole tool dependant on the position of the apparatus in the borehole.

The apparatus can determine its position in the borehole relative to the surface or to some other reference point. The apparatus is programmed to use a Bayesian approach to determine the location of the apparatus downhole, which allows the apparatus to more accurately determine its position in the borehole. Using the Bayesian approach and having pre⁻ programmed instructions to enable an action of a tool to be performed the apparatus can perform fully autonomously as does not have to receive any information from the surface to determine its position or determine what action should occur.

Preferably the borehole apparatus further comprises a downhole tool. The apparatus can control the actions of an attached tool and/or the apparatus can control the actions of a downhole tool in the borehole that is remote from the apparatus.

To estimate the position of the borehole apparatus the processor can be configured to: receive a prior location probability distribution associated with a first position of the apparatus in the borehole; receive at least one measurement from the measurement device, and calculate a posterior location probability distribution with the subsequent position, the posterior location probability distribution being conditional on the prior location probability distribution, and the or each measurement.

The measurement device is at least one sensor capable of measuring a parameter of the borehole. The apparatus can also include an odometer as a measurement device to measure the distance the apparatus has traveled along the borehole.

The downhole tool can be a measuring tool or an intervention tool.

Preferably the apparatus comprises a telemetry system. The telemetry system can provide communication between the apparatus and the surface and/or the apparatus and a remote downhole tool

Preferably the apparatus comprises a transport mechanism to move the apparatus along the borehole.

A second aspect of the invention comprises a method for performing an operation at a predetermined location in a borehole comprising: deploying the borehole apparatus as described above into the borehole; providing data to the processor from the measurement device; processing the data using a Bayesian technique to calculate the position of the borehole apparatus; determining whether the apparatus needs to perform an operation at the position calculated; and sending instructions to a downhole tool.

If it is determined that the apparatus is at a position where an operation should be performed the apparatus will initiate operation of the downhole tool. The step of determining whether an apparatus needs to perform an operation comprises relating the position of the apparatus to data stored in the data storage device. The data is preferably preloaded landmark data which is associated with particular programming statements which will send instructions to the tool. Processing the data to calculate the position of the apparatus can comprise: (a) providing a prior location probability distribution associated with a first position of the apparatus in the borehole; (b) providing at least one measurement from the measurement device, the or each measurement being associated with movement of the apparatus to a subsequent position in the borehole, and (c) calculating a posterior location probability distribution with the subsequent position, the posterior location probability distribution being conditional on the prior location probability distribution, and the or each measurement.

The method can comprise initiating a measurement operation and/or initiating an intervention operation.

The method can comprises initiating operation of a downhole tool that is attached to the apparatus and/or the method can comprise initiating operation of a downhole tool that is remote from the device.

When an operation of a downhole tool is initiated the method can comprise sending an output signal from the borehole apparatus to the remote downhole tool.

### BRIEF DESCRIPTION OF THE DRAWINGS

FIG. 1 shows an example of a borehole apparatus that can determine its position in the borehole and perform an operation at a predetermined location.

### MODE(S) FOR CARRYING OUT THE INVENTION

The invention is directed to a borehole apparatus that is capable of estimating its position in a borehole autonomously. Once the position of the apparatus has been estimated, this can trigger a downhole tool to perform a task. The apparatus can more accurately determine its position compared to apparatuses that rely solely on one positioning determining system, such as a surface depth acquisition system, to determine how far the apparatus has traveled along the borehole. By using a Bayesian approach to determine its position factors, such as conveyance stretch, conveyance compression, or odometer slippage, which can cause errors in the measurement systems, are removed or reduced.

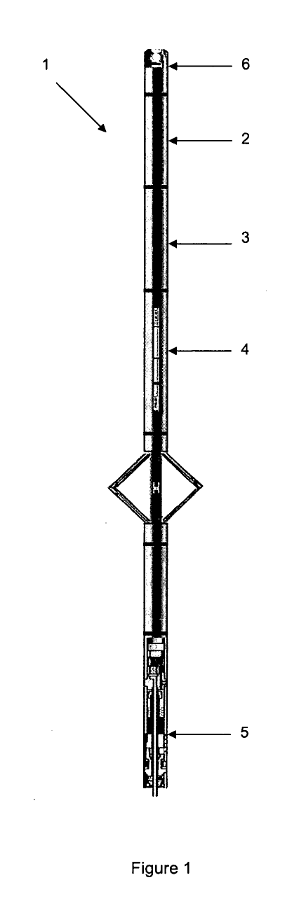

FIG. 1 shows an example of a borehole apparatus that can be used for the invention. The borehole apparatus (1) comprises a body that includes a computer system having a processor (2), a power system (3), sensors (4) and a downhole tool (5).

The computer system comprises a processor (2) that is pre-programmed to use information obtained from sensors to estimate the position of the apparatus using a Bayesian approach. The computer system comprises a data storage device, to store pre-loaded well landmark data, data obtained from the sensors and data processed by the processor. The computer system is also programmed to control the actions of a downhole tool, so that the downhole tool is instructed to perform a predetermined function when the apparatus reaches a particular position in the borehole. The computer system is programmed to relate previously obtained landmark data that are stored in the system with particular positions of the apparatus in the well. The computer system being programmed to specify particular actions that will be performed when the apparatus is at particular locations of the wellbore.

The sensors (4) can be mounted internal or externally on the apparatus. Types of sensors that can be used include casing collar locators (CCL) to detect casing joints in cased holes, sensors for detecting the presence of casing perforation, and gamma-ray sensors. The apparatus may also contain other sensors that can provide information that can be used to determine the position of the apparatus in the borehole. The borehole apparatus can also have an odometer fitted to determine the distance traveled by the apparatus along the length of the borehole.

Data from the sensors is transmitted to the processor whereby it is processed using a Bayesian approach to estimate the position of the device. The device can have multiple sensors so that a combination of data from all the sensors present can be used to provide a more accurate position estimate, than if a single sensor is used. For example, errors from odometers grow with distance, but detection of landmarks reduces the error spread again, and if one of the sensors or sources fails the data from the remaining sensors can still be used in the calculations to estimate the position of the apparatus in the borehole.

The power supply (3) provides power to the borehole apparatus, and can be provided from onboard sources such as a battery or an internal generation system.

The device can also comprise a telemetry system (6), so that information can be transmitted between the surface and the borehole apparatus and/or between the apparatus and a tool located in the borehole. Although a transmission system can be present in the apparatus, transmission of information from the surface to the apparatus is not required to determine the position of the apparatus or to initiate operation of the downhole tool. The position of the apparatus is automatically calculated from information obtained from sensors when the apparatus is downhole and the operation of the downhole tool is controlled by instructions pre-programmed into the computer system of the apparatus.

The apparatus can comprise a downhole tool (5). The operation of the downhole tool is dependent on the position of the apparatus in the borehole. The downhole tool receives instructions via an output signal from the apparatus to perform a predetermined function when the apparatus reaches a particular location in the borehole. The downhole tool can be a monitoring or intervention tool, for example, logging tools, sample collecting tools, tools for perforate casing, imaging tools, cutting or drilling tools, sensors, or tools for carrying out maintenance work in the borehole.

While the borehole apparatus is exemplified as having a downhole tool attached to the apparatus, the apparatus can also initiate operation of a downhole tool that is separate from the apparatus. In this situation the downhole tool is able to receive a signal, that is sent from the apparatus to the tool, and which will initiate an action of the tool. The signal is generated when it is determined that the apparatus is at a particular position that corresponds to the task that is to be performed.

The apparatus can also comprise a transport mechanism to move the apparatus through the borehole. The transport mechanism is able to move the apparatus along the borehole without control from outside the borehole. The transport mechanism is powered by the onboard power system.

The apparatus does not require any permanent connection to the surface to operate, such as a wire, umbilical, or cables. However connections can be present, for example to allow data to be transmitted to the surface, to initially deploy the apparatus into the borehole or to provide power to the onboard power system. The apparatus can be lowered down the borehole on a wireline and when it reaches a particular location, can be released from the wireline such that it can move along the wellbore independently without any control from the surface. Its autonomous movement along the wellbore being controlled by instructions pre-programmed into the computer system of the apparatus. The position of the apparatus is calculated by the on-board processor from data the processor has received from sensors. When it is determined that the apparatus is at a particular location of the borehole, a downhole tool can be activated to perform a particular function.

In order to determine the position of the apparatus in the borehole a Bayesian approach as described in GB 2396219 can be used, whereby the location probability distribution at one position is used in the calculation of the location probability distribution of the following position.

Although like conventional dead-reckoning approaches to downhole position estimates, the method can result in increasing errors as the distance traveled by the apparatus increases, an advantage of using the Bayesian approach is that the extent of the error can be quantified by the probability distribution. This is particularly useful if the method is being used to track an apparatus that is to perform a critical operation, such as casing perforation, at a predetermined position in the wellbore. For example, even if the apparatus is tracked to the region to the predetermined position, an apparatus may choose to abort such an operation if there is an indication that the probability distribution is insufficiently focused on that position.

The approach allows measurements which may derive from different sources to be combined in the calculation of the location probability distribution. The measurement may derive from disparate sources but still all carry useful information about the repositioning of the apparatus. Combining such information is advantageous because the range of likely positions for the apparatus, as defined by the location probability distribution is itself likely to be narrower when the amount of the information used to calculate the probability distribution is increased.

In one embodiment for determining the position of the apparatus the Bayesian approach involves: providing a prior location probability distribution associated with a first position of the apparatus in the borehole; providing a measurement of a putative distance moved by the apparatus and/or measurement of a characteristic of the surroundings of the apparatus, the or each measurement being associated with movement of the apparatus to a subsequent position in the borehole, and calculating a posterior location probability distribution with the subsequent position, the posterior location probability distribution being conditional on the prior location probability distribution, and the or each measurement.

When the borehole apparatus is deployed down the borehole the processor is initially set with a reference to the surface entry point into the borehole, so that when the device is at the top of the well the device begins with an initial probability distribution function (PDF) that is narrow and located at the top of the well. As the apparatus moves along the borehole a measurement of the putative distance moved and/or the characteristic of the surrounding of the apparatus is provided to the processor. Each measurement is associated with movement of the apparatus to a subsequent position in the borehole. A posterior location probability distribution associated with the subsequent position is calculated. The posterior location probability distribution being conditional on the prior location probability of each measurement. These steps are repeated for determining further positions of the apparatus as the apparatus moves along the borehole, with the posterior location probability of one repeat becoming the prior location probability distribution of the following repeat. The apparatus can proceeds down the borehole and is able to continuously calculate its position in the borehole.

Once the position of the apparatus has been determined, this information is used by the apparatus to dictate decision making and to control other tools in the borehole autonomously. Controlling other tools can include directing further data monitoring or measuring to occur or to activate an intervention operation. The apparatus is pre-programmed with previously obtained landmark data and with instructions which cause specific functions at particular locations and depths of the well to occur. The monitoring and intervention tools are sent commands based on the position of the apparatus.

For example, once the position of the apparatus has been estimated, and an acceptable probability has determined that the apparatus is at the required position in the well and/or adjacent a particular downhole device, the positioning information calculated will relate to particular internal landmark data and conditional programming statements that are stored by the computer system. This will results in instructions being sent to the downhole tool so that the action can occur. These landmark data and statements will determine when, where and what action will be performed by the downhole tool. However if the probability distribution determined is not sufficiently focused at a particular position then apparatus will not cause a particular action to occur.

The action to be performed may either be a single action that is pre-programmed, a series of actions, or can vary the action of a tool dependant on what the apparatus has determined while acquiring data to determine its location. For example if the well is hotter than expected or fluid is more or less dense than expected at a particular depth of the well this may indicate a favorable or non-favorable condition, which will determine a particular action. The action could involve the activation of a mechanical action tool, i.e. to turn, push, vibrate, release or set in position a device or tool, such as plug setting or plug pulling. It could release micro-sensors, retrieve a device from the wellbore by latching, repairing by milling or grinding, or transmit and receive data by RF, EMF or other wireless means.

In one embodiment when the apparatus recognizes it is at a particular location in the borehole, a particular task can be performed by the downhole tool of the apparatus. In another embodiment when the apparatus recognizes it is at a particular location in the borehole, the apparatus sends a signal to a further tool already present in the borehole to perform a function. Such functions can include logging work, collecting samples, imaging, measuring, perforating, plugging, drilling, and maintenance operations.

The computer system is pre-programmed with instructions, such that the apparatus can send a signal to a downhole tool depending on the position of the apparatus resulting in the tool performing some action. This occurs automatically without the need for communication with the surface to receive instructions for the tool to perform an operation. With both the operation of the downhole tool controlled by the computer system of the apparatus and the position of the apparatus determined without communication with the surface, the apparatus is fully autonomous.

When the action of the tool is to take measurements, these measurements taken can be associated with a particular location in the wellbore. They can be stored on a data storage device of the apparatus to be retrieved later when the apparatus returns to the surface. Alternatively the measurements are transmitted to the surface in real-time.

Other changes can be made to the device while still remaining within the scope of the invention.

1. A borehole apparatus capable of autonomously estimating position of the apparatus in a borehole and controlling the actions of a downhole tool located in the borehole, the apparatus comprising:
a body;
at least one measurement device capable of measuring a parameter of the borehole or the distance traveled by the at least one measurement device;
a computer system located in the body, the computer system comprising; a processor arranged to receive data from the at least one measurement device and to calculate the position of the apparatus in the borehole; and a data storage device capable of storing data that has been processed by the processor and for storing instructions to control the actions of the downhole tool; and
a power system;
wherein the computer system is configured to process the data gathered from the at least one measurement device to estimate the position of the downhole tool using a Bayesian approach and configured to provide output signals to control an action of the downhole tool dependant on the position of the apparatus in the borehole.

2. The borehole apparatus according to claim 1 comprising a downhole tool.

3. The borehole apparatus according to claim 1 wherein to estimate the position of the borehole apparatus the processor is configured to:
receive a prior location probability distribution associated with a first position of the apparatus in the borehole;
receive at least one measurement from the at least one measurement device, and calculate a posterior location probability distribution with the subsequent position, the posterior location probability distribution being conditional on at least one of the prior location probability distribution, and each measurement.

4. The borehole apparatus according to claim 1 wherein the at least one measurement device comprises at least one sensor capable of measuring a parameter of the borehole.

5. The borehole apparatus according to claim 1 wherein the at least one measurement device is an odometer.

6. The borehole apparatus according to claim 1 wherein the downhole tool is a measuring tool.

7. The borehole apparatus according to claim 1 wherein the downhole tool is an intervention tool.

8. The borehole apparatus according to claim 1 further comprising a telemetry system.

9. The borehole apparatus according to claim 1 further comprising a transport mechanism to move the apparatus along the borehole.

10. A method for performing an operation at a predetermined location in a borehole comprising:
deploying the borehole apparatus of claim 1 into the borehole;
providing data to the processor from the at least one measurement device;
processing the data using a Bayesian technique to calculate the position of the borehole apparatus;
determining whether the apparatus needs to perform an operation at the position calculated; and
sending instructions to a downhole tool.

11. The method according to claim 10 wherein the step of determining whether the apparatus needs to perform an operation comprises relating the position of the apparatus to data stored in the data storage device.

12. The method according to claim 10 wherein processing the data comprises:
providing a prior location probability distribution associated with a first position of the apparatus in the borehole;
providing at least one measurement from the at least one measurement device, the at least one measurement being associated with movement of the apparatus to a subsequent position in the borehole, and
calculating a posterior location probability distribution with the subsequent position, the posterior location probability distribution being conditional on at least one of the prior location probability distribution, and the at least one measurement.

13. The method according to claim 10 comprising initiating a measurement operation.

14. The method according to claim 10 comprising initiating an intervention operation.

15. The method according to claim 10 comprising initiating operation of a downhole tool that is attached to the apparatus.

16. The method according to claim 10 comprising initiating operation of a downhole tool that is remote from the device.

17. The method according to claim 16 comprising sending an output signal from the borehole apparatus to the remote downhole tool.
